(19) United States
(12) Patent Application Publication
(10) Pub. No.: US 2005/0047540 A1
(43) Pub. Date: Mar. 3, 2005

(54) Phase detector and method of detecting phase

(75) Inventor: Young-Kyun Cho, Suwon-si (KR)

Correspondence Address: Steven M. Mills;MILLS & ONELLO LLP, Suite 605, Eleven Beacon Street, Boston, MA, 02108, US

(73) Assignee: Samsung Electronics Co., Ltd.

(21) Appl. No.: 10/931,913

(22) Filed: Sep. 1, 2004

(30) Foreign Application Priority Data
Sep. 2, 2003 (KR) 03-61102

(51) Int. Cl. H04L 25/49

(52) U.S. Cl. 375/375

(57) ABSTRACT

Disclosed is a method for rapidly and precisely detecting phase by a level trigger method. A phase detector includes a false lock preventing section which includes multiple latches, a lock discriminating section and a reset section. An input signal is sequentially latched to a reference signal and multiple delay signals to generate first and second latch signals different in phase from the reference signal. First and second lock discriminating signals having information about phase of the reference signal and phases of the delay signals are generated by the first and second latch signals. A reset signal is generated by a NAND gate when first and second lock discriminating signals are received. The reset signal reverses the latch signals and lock discriminating signals. A phase difference between reference signal and delay signals is detected by receiving reversed lock discriminating signals. Phases are rapidly detected by using latches.

### CROSS-REFERENCE TO RELATED APPLICATIONS

This application claims priority from Korean Patent Application No. 2003-61102, filed on Sep. 2, 2003, the contents of which are incorporated herein by reference in their entirety.

### BACKGROUND OF THE INVENTION

1. Field of the Invention

The present invention relates to a phase detector and a method of detecting phase. More particularly, the present invention relates to a method of detecting phase and a phase detector capable of rapidly detecting phase.

2. Description of the Related Art

A Delay Locked Loop (DLL) generates a plurality of delay signals from a plurality of delay elements. The delay signals should have a definite phase relationship with a reference signal so that the delay signals may have predetermined phase differences from the reference signal. However, the desired delay signals having the predetermined phase differences may not be generated due to time delay by various causes. Therefore, there is a need for a phase detector capable of having the desired phase differences between the reference signal and the delay signals. The phase detector compares phases of the delay signals with the phase of the reference signal to generate information concerning a delay time. As a result, the DLL including the phase detector varies the delay signals by the delay time to generate the desired delay signal. This condition is designated as locking.

A conventional phase detector does not discriminate between t1 and T (period)+t1. As a result, even though the delay signal should be locked at t1, the DLL may discriminate that the delay signals is locked at T+t1. In addition, the conventional phase detector detects the phase late. One prior art solution to the problem of the false locking is disclosed in U.S. Pat. No. 6,215,343, which proposes a delay locked loop to eliminate the false locking, which comprises a chain of at least two delay elements consisting of multiple flip-flops having an input and an output, a phase comparator having first and second inputs and an output for delivering a binary control signal, and a converter for converting the binary control signal into an analog control signal. In such a technique, initialization flip-flops and the chain of flip-flops are triggered by clock inputs so that the outputs of the flip-flops are changed. Therefore, in a chain of multiple flip-flops, speed delay in each of flip-flops is accumulated, thereby resulting in great delay in total operation speed between the initial input terminal and final output terminal.

### SUMMARY OF THE INVENTION

Accordingly, the present invention is provided to substantially obviate one or more problems due to limitations and disadvantages of the related art.

It is a feature of the present invention to provide a method of detecting phase at improved speed and a phase detector, in which the phase difference can be detected more rapidly and accurately.

In accordance with one aspect of the invention, a method of detecting phase latches in sequence an input signal to a reference signal and a plurality of delay signals different in phase from the reference signal, thereby generating a first and second latch signals. First and second lock discriminating signals are generated using the first and second latch signals. The first and second lock discriminating signals include information concerning the phase of the reference signal and the phases of the delay signals, respectively. A reset signal is generated using the first and second lock discriminating signals. The first and second latch signals and the first and second lock signals are reversed using the reset signal. The phase difference between the reference signal and the delay signals is detected using the reversed first and second lock discriminating signals.

In accordance with another aspect of the invention, a method of detecting phase latches an input signal having high logic to a plurality of delay signals to generate first and second latch signals, wherein the delay signals have in sequence predetermined phase difference from the reference signal. The latch signals pass through D flip-flops to generate first and second lock discriminating signals having information concerning phases of the reference signal and the delay signals, respectively. A logical NAND operation is performed on the lock discriminating signals to generate a reset signal. The latch signals and the lock discriminating signals are reversed using the reset signal. The phase difference between the reference and the delay signals is detected using the reversed lock discriminating signals.

In accordance with another aspect of the invention, a phase detector includes a false lock preventing section, a lock discriminating section and a reset section. The false lock preventing section latches in sequence an input signal to a reference signal and a plurality of delay signals different in phase from of the reference signal, thereby generating first and second latch signals. The lock discriminating section receives the first and second latch signals to generate a first and second lock discriminating signals, which include information concerning the phases of the reference signal and the delay signals respectively. The reset section receives the first and second lock discriminating signals to reverse the latch signals and the lock discriminating signals.

In accordance with another aspect, a phase detector includes a false lock preventing section, a lock discriminating section and a reset section. The false lock preventing section latches an input signal having high logic to a plurality of delay signals, thereby generating first and second latch signals, wherein phases of the delay signals have predetermined difference from phase of the reference signal. The lock discriminating section allows the first and second latch signals to pass through D flip-flops so that first and second lock discriminating signals having information concerning the phases of the reference signal and the delay signals may be generated. The reset section receives the lock discriminating signals to perform a logical NAND operation on the lock discriminating signals so that a reset signal may be generated, wherein the reset signal reverses the latch signals and the lock discriminating signals.

As described above, a method of detecting a phase and a phase detector rapidly detect the phases of the signals using the latches.

In addition, the method of detecting the phase and the phase detector compare the phases of signals using the latches coupled in series, the phases thereof are exactly detected.

### BRIEF DESCRIPTION OF THE DRAWINGS

The foregoing and other features and advantages of the invention will be apparent from the more particular description of an embodiment of the invention, as illustrated in the accompanying drawing. The drawing is not necessarily to scale, emphasis instead being placed upon illustrating the principles of the invention.

FIG. 1 is a block diagram illustrating a phase detector according to an embodiment of the invention.

FIG. 2 is a block diagram illustrating a lock discriminating section according to an embodiment of the invention.

FIG. 3 is a schematic view illustrating the circuit of the phase detector according to an embodiment of the invention.

FIG. 4 is a timing diagram illustrating detecting phase in a conventional phase detector.

FIG. 5 is another timing diagram illustrating detecting phase in the conventional phase detector.

FIG. 6 is a timing diagram illustrating operation of the phase detector according to an embodiment of the invention.

FIG. 7 is a timing diagram illustrating operation of the phase detector according to an embodiment of the invention.

FIG. 8 is a timing diagram illustrating operation of the phase detector according to an embodiment of the invention.

FIG. 9 is a timing diagram illustrating operation of the phase detector according to an embodiment of the invention.

FIG. 10 is a flow chart illustrating operation of the DLL using the phase detector of the invention.

FIG. 11 is a timing diagram illustrating the improvement in speed of the phase detector according to the present invention.

### DETAILED DESCRIPTION OF THE INVENTION

Detailed illustrative embodiments of the present invention are described herein. However, specific structural and functional details disclosed herein are merely representative for purposes of describing exemplary embodiments of the present invention.

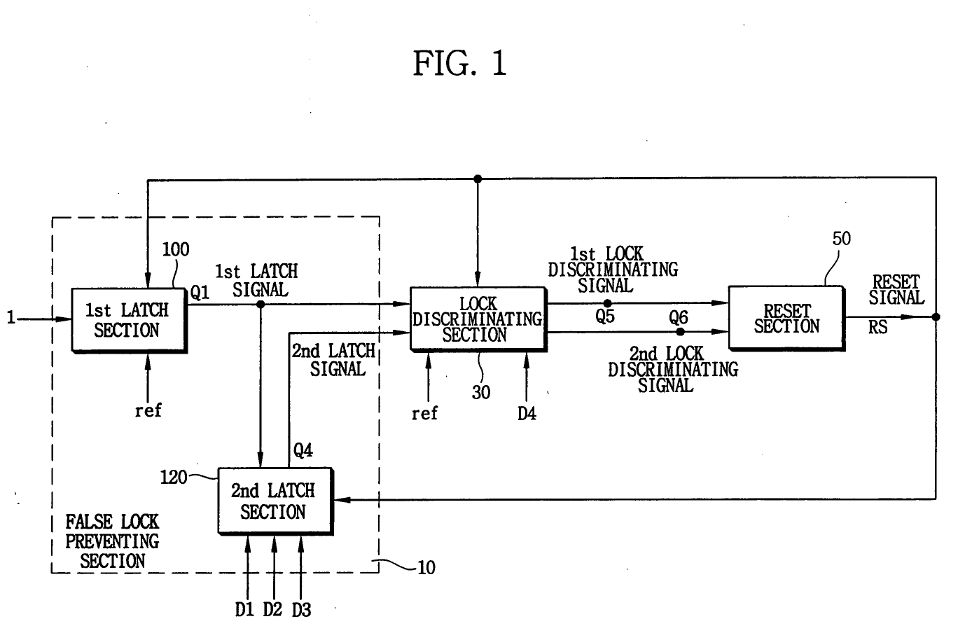

FIG. 1 is a block diagram illustrating a phase detector according to an embodiment of the invention.

Referring to FIG. 1, the phase detector of the invention includes a false lock preventing section 10, a lock discriminating section 30 and a reset section 50.

The phase detector may be used for a Delay Locked Loop (DLL). The DLL has less jitter than a Phase Locked Loop (PLL) and is less sensitive to noise than the PLL.

The false lock preventing section 10 latches in sequence an input signal to a reference signal ref and a plurality of delay signals, thereby generating a first latch signal Q1 and a second latch signal Q4 for preventing the false locking. The phases of the delay signals are different from the phase of the reference signal. The input signal has a high logic; that is, the input signal is logical “1”. The delay signals have predetermined phase differences in sequence from the reference signal. For the purpose of an illustrative example, the number N of the delay signals is chosen to be 4. In this case, the delay signals include a first delay signal D1, a second delay signal D2, a third delay signal D3 and a fourth delay signal D4. At this time, the first delay signal D1 has T/4 phase difference from the reference signal, the second delay signal D2 has T/2 phase difference from the reference signal, the third delay signal D3 has 3 T/4 phase difference from the reference signal, and the fourth delay signal D4 has T phase difference from the reference signal. The T indicates the period of the reference signal.

The lock discriminating section 30 receives the first latch signal Q1 and the second latch signal Q4 to generate a first lock discriminating signal Q5 and a second lock discriminating signal Q6 so that it discriminates phases of the reference signal and the delay signals. In detail, the lock discriminating section 30 receives the first latch signal Q1 and the second latch signal Q4 and passes the signals Q1 and Q4 through a flip flop to generate the first lock discriminating signal Q5 and the second lock discriminating signals Q6. In addition, the lock discriminating section 30 provides the generated first and second lock discriminating signals Q5 and Q6 to a reset section 50.

The reset section 50 receives the first and second lock determining signals Q5 and Q6 to generate a reset signal. Particularly, the reset section 50 passes the first and second lock discriminating signals through a NAND gate to generate the reset signal. The reset signal is transmitted to the false lock preventing section 10 and the lock discriminating section 30.

The phase detector of the invention further includes a comparing section (not shown) for comparing the first lock discriminating signal Q5 with the second lock discriminating Q6 signal to generate a comparison signal having information concerning the comparison result.

The false lock preventing section 10 includes a first latch section 100 and a second latch section 120.

The first latch section 100 latches the input signal having a high logic to the reference signal, thereby generating the first latch signal Q1.

The second latch section 120 latches in sequence the first latch signal Q1 to the delay signals D1, D2 and D3, thereby generating the second latch signal Q4. Particularly, the second latch section 120 shifts the first latch signal Q1 in correspondence with the delay signals D1 to D3.

Because the phase detector of the invention latches the input signal to the delay signals for locking, the phase detector can perform rapidly the locking operation compared to a conventional phase detector.

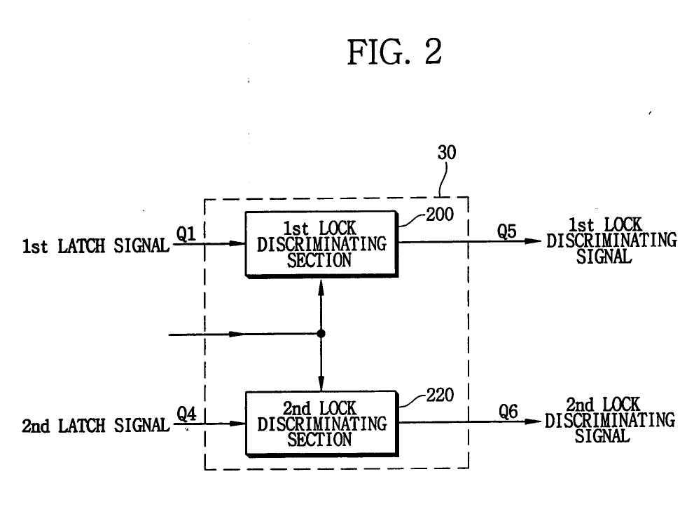

FIG. 2 is a block diagram illustrating the lock discriminating section 30 according to an embodiment of the invention.

Referring to FIG. 2, the lock discriminating section 30 includes a first lock discriminator 200 and a second lock discriminator 220.

The first lock discriminator 200 receives the first latch signal Q1 and passes the signal Q1 through a first flip-flop to generate the first lock discriminating signal.

The second lock discriminator 220 receives the second latch signal Q4 and passes the signal Q4 through a second flip-flop to generate the second lock discriminating signal Q6.

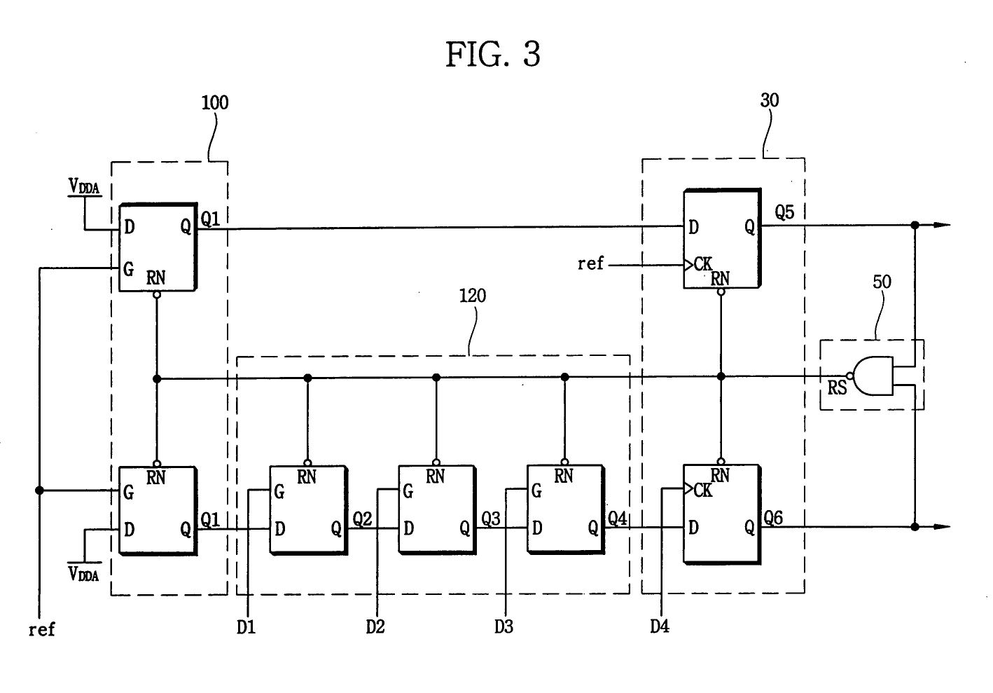

FIG. 3 is a schematic view illustrating a circuit of the phase detector according to an embodiment of the invention.

As shown in FIG. 3, the first latch section 100 includes two D latches. The D latches include a reset terminal and an output terminal. The D latches latch the input signal of high logic to the reference signal, thereby generating an output signal. Here, the output signals corresponding to the D latches are substantially identical to each other. Therefore, the first latch section 100 may generate an output signal Q1 using a D latch, and transmit the output signal Q1 to the second latch section 120 and the lock discriminating section 30. On the other hand, load of the circuit of the invention is smaller when the first latch 100 employs the two D latches than when the first latch 100 employs one D latch.

The second latch section 120 includes a plurality of latches. The latches are coupled in series. For example, the latches include a first latch, a second latch and a third latch. The input terminal of the first latch is coupled to the first latch section 100. The output terminal of the first latch is coupled to the input terminal of the second latch. The output terminal of the second latch is coupled to the input terminal of the third latch. In addition, the first latch receives a first delay signal D1. The second latch receives a second delay signal D2. The third latch receives a third delay signal D3. The delay signals D1 to D3 have predetermined phase difference in sequence from the reference signal.

The lock discriminating section 30 includes a first flip-flop and a second flip flop. The first flip-flop is coupled in parallel to the second flip-flop.

The reset section 50 includes a NAND gate. The NAND gate is coupled to the first flip-flop and the second flip-flop.

The first latch section 100 and the second latch section 120 of the invention employ the latches instead of a plurality of flip-flops. Therefore, the phase detector of the invention compares rapidly phases of the delay signals with phase of the reference signal compared to a conventional phase detector.

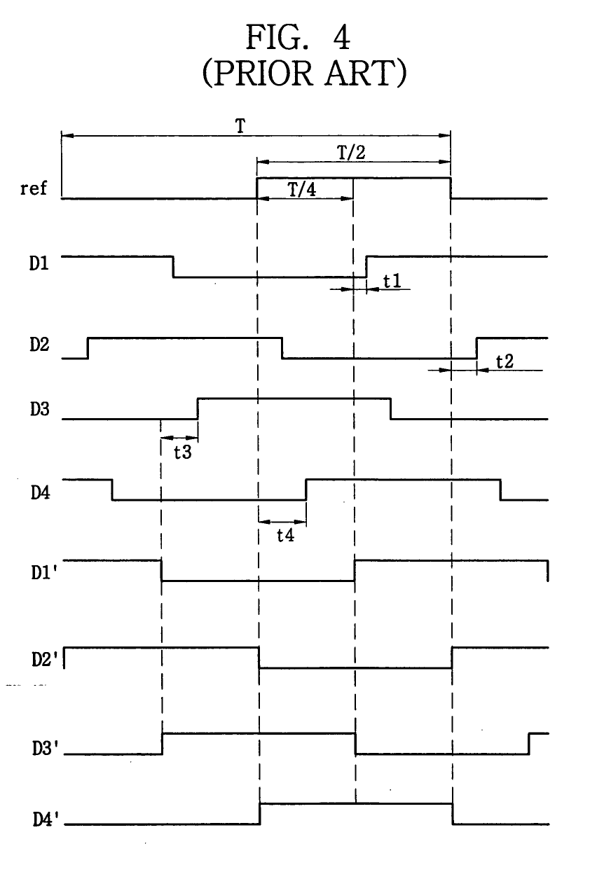

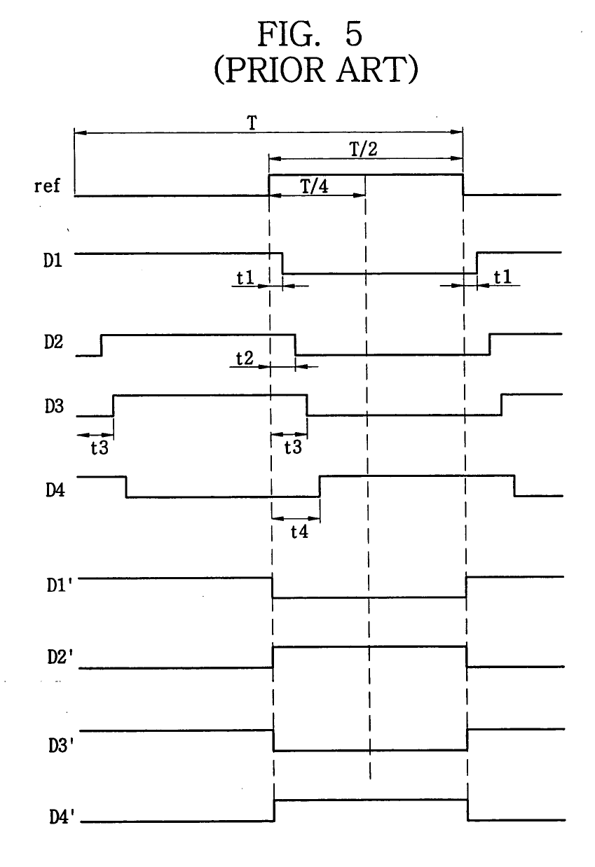

FIG. 4 contains a timing diagram that illustrates operation of detecting a phase in the conventional phase detector, and FIG. 5 contains another timing diagram that illustrates operation of detecting a phase in the conventional phase detector.

Referring to FIG. 4, in case of locking, the delay signals have T/4 phase difference in sequence from the reference signal. However, the delay signals have delays by various cases, and so the first delay signal D1, the second delay signal D2, the third delay signal D3 and the fourth delay signal D4 as shown in, FIG. 4 are generated. Hence, in the DLL, the delay signals ought to be locked. The first to third delay signals are locked when the fourth delay signal is locked. This is because the first to third delay signals are latched in sequence.

Referring to FIG. 5, the first delay signal D1 has T/4+t1 phase difference from the reference signal. The second delay signal D2 has T/2+t2 phase difference from the reference signal. The third delay signal D3 has 3 T/4+t3 phase difference from the reference signal. The fourth delay signal D4 has T+t4 phase difference from the reference signal. Therefore, the T+t4 phase difference ought to be compensated for locking. However, the DLL employing a conventional phase detector stops the compensating operation after compensating the fourth delay signal D4 by t4. This is because the conventional phase detector does not discriminate between t4 and T+t4 so that the conventional phase detector determines incorrectly that the phase of the compensated fourth delay signal is substantially identical to that of the reference. This indicates false lock.

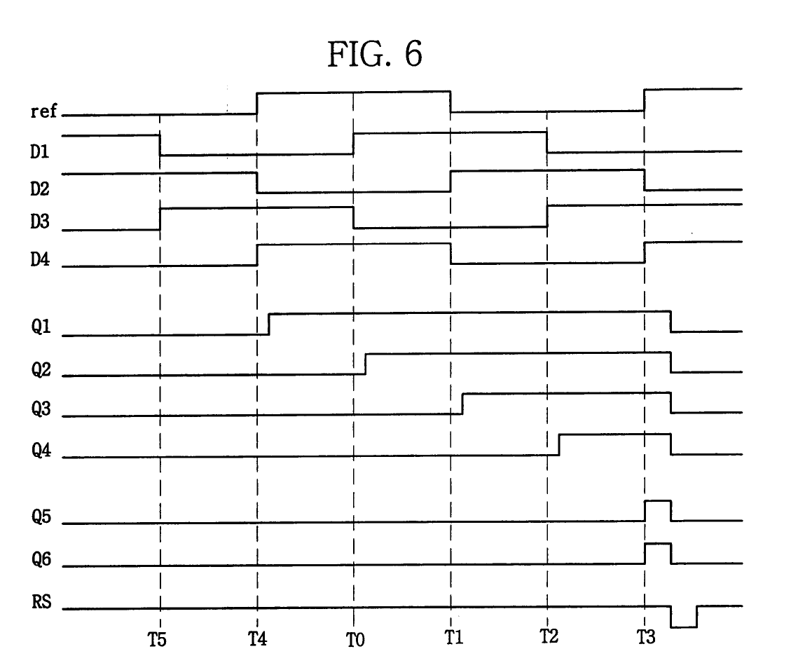

FIG. 6 is a timing diagram illustrating operation of the phase detector according to an embodiment of the invention.

As shown in FIG. 6, when the delay signals are locked with the reference signal, the first lock discriminating signal Q5 is substantially identical to the second lock discriminating signal Q6. That is, when the first lock discriminating signal Q5 is substantially identical to the second lock discriminating signal Q6, the delay signals are locked.

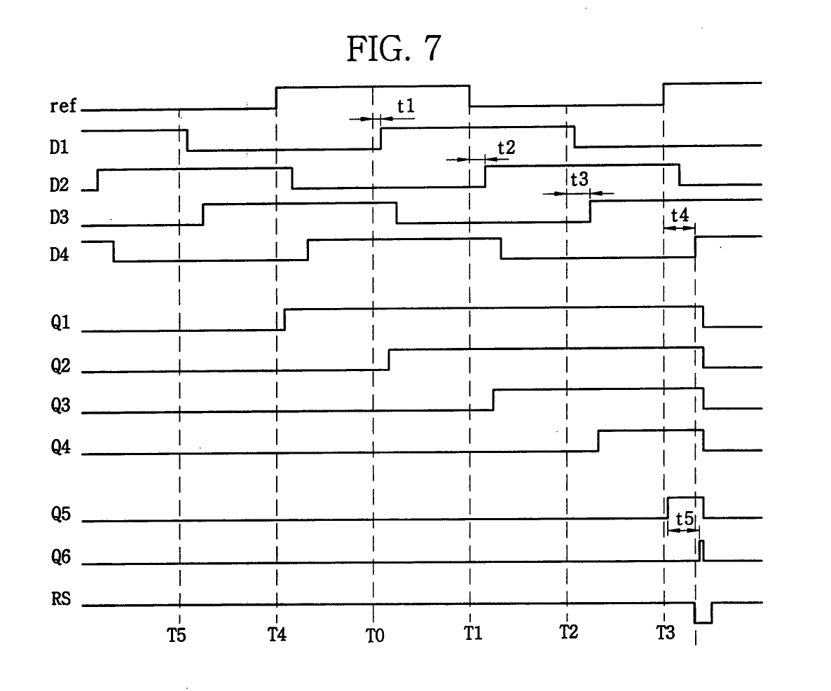

FIG. 7 is a timing diagram illustrating operation of the phase detector according to an embodiment of the invention.

As shown in FIG. 7, the delay time of the first delay signal D1 is t1, and that of the second delay signal D2 is t2. In addition, the delay time of the third delay signal D3 is t3, and that of the fourth delay signal D4 is t4.

Now referring to FIG. 3, the first latch signal corresponds to a Q1 signal in FIG. 7. When a delay signal has high logic, a D latch reads input data, whereas when the delay signal has low logic, the D latch keeps the read input data. The logic of reference signal is changed from low to high at T4. Because the input signal has high logic, the data of the input signal at T4 is read. As a result, the Q1 signal is generated.

The second latch section 120 of the invention includes latches coupled in series to each other. The first latch receives the Q1 signal and the first delay signal D1. Therefore, the data of the Q1 signal is read at T0+t1, and so the first latch generates a Q2 signal. The second latch receives the Q2 signal and the second delay signal D2. Therefore, the data of the Q2 signal is read at T1+t2, and so the second latch generates a Q3 signal. The third latch receives the Q3 signal and the third delay signal D3. Therefore, the Q3 signal is read at T4+t3, and so the third latch generates the Q4 signal.

The first latch signal Q1 is inputted into a first flip-flop of the lock discriminating section 30, and the reference signal is provided to the first-flip flop as a clock. Therefore, the data of the first latch signal Q1 is read at T3, and so the first lock discriminating signal Q5 is generated from the first flip-flop. The Q4 signal is inputted into the second flip-flop of the lock discriminating section 30, and the fourth delay signal D4 is provided to the second flip-flop as a clock. Therefore, the data of the Q4 signal is read at T3+t4, and so the second lock discriminating signal Q6 is generated.

The first and second lock discriminating signals Q5 and Q6 are inputted into the NAND gate. As a result, the reset signal RS is generated from the NAND gate. When each of the first and second lock discriminating signals Q5 and Q6 is high logic, the logic of the reset signal RS is low. The reset signal resets the latches and the flip-flops. Hence, the Q1 signal, the Q2 signal, the Q3 signal, the Q4 signal, the first lock discriminating signal Q5 and the second lock discriminating signal Q6 are reversed as shown in FIG. 7. When the reversed first lock discriminating signal is compared with the reversed second lock discriminating signal, time difference corresponding to t5 is generated. Therefore, the DLL changes delay time corresponding to the t5. Particularly, the delay time corresponding to the t5 ought to be reduced.

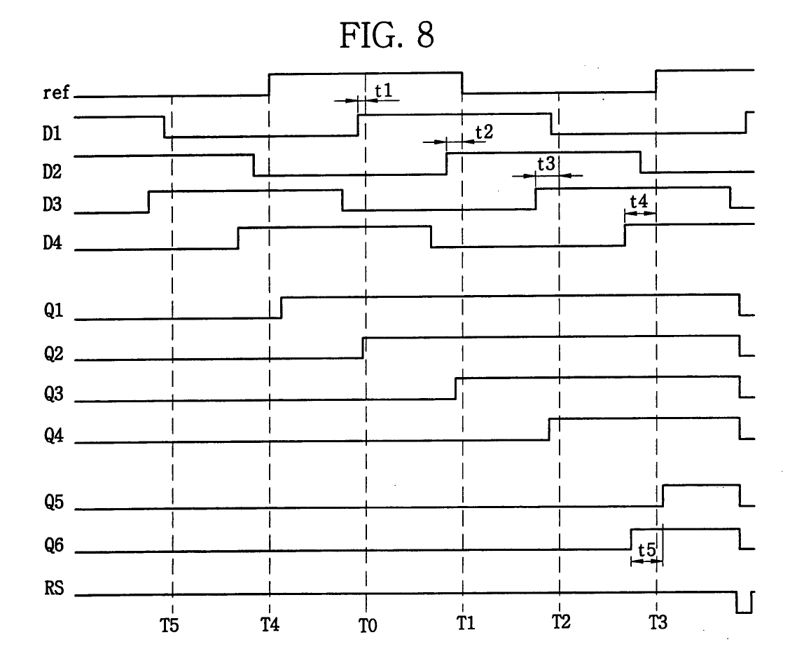

FIG. 8 is a timing diagram illustrating operation of the phase detector according to one embodiment of the invention.

As shown in FIG. 8, the delay time of the first delay signal D1 is reduced by t1. The delay time of the second delay signal D2 is reduced by t2. The delay time of the third delay time is reduced by t3. The delay time of the fourth delay signal D4 is reduced by t4.

Now referring to FIG. 3, the first latch signal corresponds to a Q1 signal in FIG. 8. The logic of the reference signal is converted from low into high. Because the input signal has high logic, the data of the input signal is read at T4. As a result, the Q1 signal is generated. The first latch of the latch section 120 receives the Q1 signal and the first delay signal D1. Therefore, the data of the Q1 signal is read at T0−t1, and so the first latch generates a Q2 signal. The second latch thereof receives the Q2 signal and the second delay signal D2. Therefore, the data of the Q2 signal is read at T1−t2, and so the second latch generates a Q3 signal. The third latch thereof receives the Q3 signal and the third delay signal D3. Therefore, the data of the Q3 signal is read at T2−t3, and so the third latch generates a Q4 signal.

The first latch signal Q1 is inputted into the first flip-flop of the lock discriminating section 30, and the reference signal is provided to the first flip-flop as a clock. Therefore, the data of the first latch signal Q1 is read. As a result, the first lock discriminating signal Q5 is generated. The Q4 signal is inputted into the second flip-flop of the lock discriminating section 30, and the fourth delay signal D4 is provided to the second flip-flop of the lock discriminating section 30 as clock. Therefore, the data of the Q4 signal is read at T3−t4. As a result, the second lock discriminating signal Q6 is generated.

The first and second lock discriminating signals Q5 and Q6 are inputted into the NAND gate. As a result, the reset signal RS is generated. When each of the first and second lock discriminating signals Q5 and Q6 has high logic, the logic of the reset signal RS is low. The reset signal RS resets the latches and the flip-flops. Hence, the Q1 signal, the Q2 signal, the Q3 signal, the Q4 signal, the first lock discriminating signal Q5 and the second lock discriminating signal Q6 are reversed as shown in FIG. 7. When the reversed first lock discriminating signal is compared with the reversed second lock discriminating signal, time difference corresponding to t5 is generated. Therefore, the DLL changes delay time corresponding to the t5. In detail, the delay time corresponding to t5 ought to be augmented.

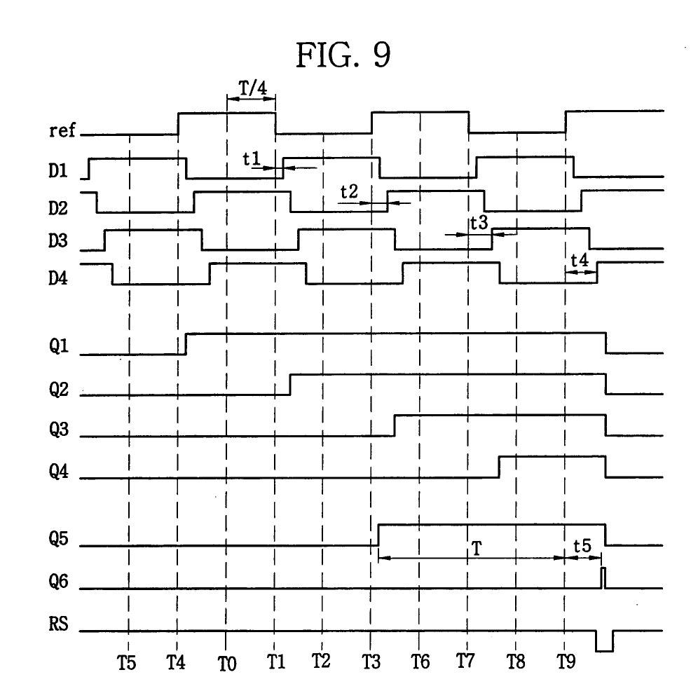

FIG. 9 is a timing diagram illustrating operation of the phase detector according to an embodiment of the invention.

As shown in FIG. 9, the delay time of the first delay signal D1 is T/4+t1. The delay time of the second delay signal D2 is 2 T/4+t2. The delay time of the third delay signal D3 is 3 T/4+t3. The delay time of the fourth delay signal D4 is T+t4.

Now referring to FIG. 3, the first latch signal corresponds to a Q1 signal in FIG. 7. The logic of the reference is converted from low into high at T4. Because the logic of the input signal is high, the data of the input signal is read at T4. As a result, the Q1 signal is generated. The second latch section 120 of the invention includes latches coupled in series to each other. The first latch of the second latch section 120 receives the Q1 signal and the first delay signal D1. Therefore, the data of the Q1 signal is read at T1+t1, and so the first latch generates a Q2 signal. The second latch of the second latch section 120 receives the Q2 signal and the second delay signal D2. Therefore, the data of the Q2 signal is read at T3+t2, and so the second latch generates a Q3 signal. The third latch receives the Q3 signal and the third delay signal D3. Hence, the Q3 signal is read at T7+t3. As a result, the third latch generates a Q4 signal.

The first latch signal Q1 is inputted into the first flip-flop of the lock discriminating section 30, and the reference signal is provided to the first flip-flop as a clock. Therefore, the data of the first latch signal Q1 is read. As a result, the first flip-flop generates the first lock discriminating signal Q5. The Q4 signal is inputted into the second flip-flop. The fourth delay signal D4 is provided to the second flip-flop as clock. Therefore, the data of the Q4 signal is read at T9+t4. As a result, the second flip-flop generates the second lock discriminating signal Q6.

The first and second lock discriminating signals Q5 and Q6 are inputted into the NAND gate. As a result, the reset signal RS is generated. When each of the first and second lock discriminating signals Q5 and Q6 has high logic, the logic of the reset signal RS is low. The reset signal RS resets the latches and the flip-flops. Hence, the Q1 signal, the Q2 signal, the Q3 signal, the Q4 signal, the first lock discriminating signal Q5 and the second lock discriminating signal Q6 are reversed as shown in FIG. 7. When the reversed first lock discriminating signal is compared with the reversed second lock discriminating signal, time difference corresponding to T+t5 is generated. The phase detector of the invention discriminates between T+t5 and t5. Therefore, the DLL employing the phase detector does not stop operation after reducing delay time by t5, and stop operation after reducing delay time by T+t5. Hence, the DLL employing the phase detector locks exactly without the false lock.

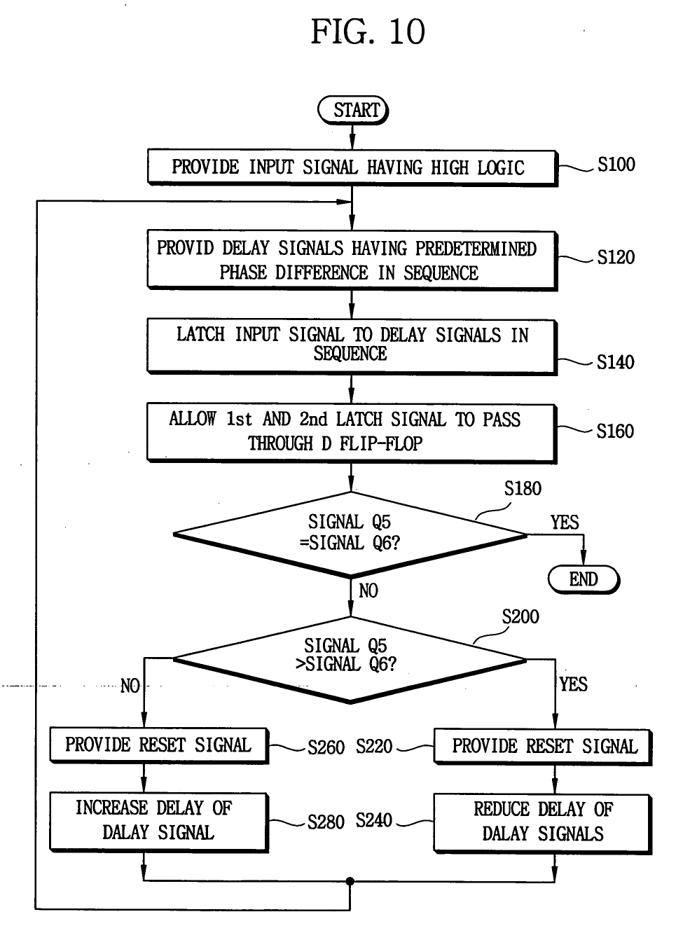

FIG. 10 is a flow chart illustrating operation of the DLL using the phase detector of the invention.

Referring to FIG. 10, in step S100, the input signal having high logic is provided. In step S120, the delay signals having predetermined phase difference in sequence from the reference is provided. In step S140, the input signal is latched to the delay signals so that the first and second latch signals are generated. In step S160, the first and second latch signals are passed through the flip-flops so that the first and second lock discriminating signals are generated. In step S180, when the first and second lock discriminating signals are reversed, it is determined whether or not the reversed first lock discriminating signal is substantially identical to the reversed second lock discriminating signal.

In step S200, when the reversed first lock discriminating signal is substantially identical to the reversed second lock discriminating signal, operation of detecting the phase is finished. Whereas, when the reversed first lock discriminating signal is not identical to the reversed second lock discriminating signal, it is determined whether or not the delay time of the reversed first lock discriminating signal is larger than that of the reversed second lock discriminating signal.

In step S220, when the delay time of the first lock discriminating signal is longer than that of the reversed second lock discriminating signal, the reset signal is provided. In step S240, the delay of the delay signals is reduced. In step S260, when the delay time of the first lock discriminating signal is shorter than that of the reversed second lock discriminating signal, the reset signal is provided. In step S280, the delay of the delay signals is increased. The changed delay signals are provided.

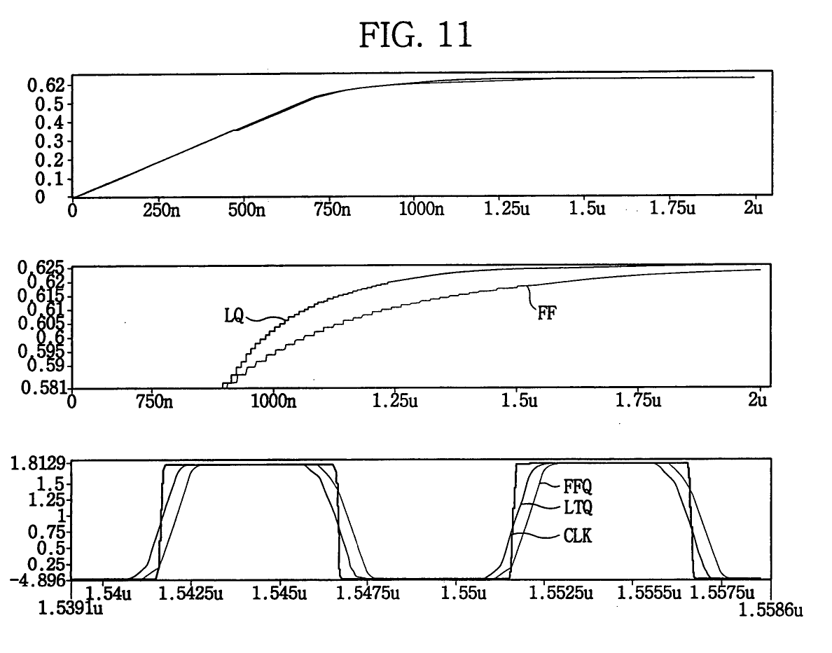

Referring to FIG. 11, according to the phase detector of the present invention, it can be understood that improvement on speed may be accomplished by constructing the false lock protecting section 10 with latch substituted for flip-flop. Namely, at ½ level of a rising edge of clock signal CLK, a latch output signal LTQ passes almost ½ level of a rising edge thereof simultaneously with the clock signal CLK. However, a flip-flop output signal FFQ does not pass ½ level of a rising edge thereof.

Accordingly, in a chain structure in which N of flip-flops connected are connected in serial to each other, each unit delay time of flip-flops is accumulated so that the total delay time is greatly increased, namely N times as large as unit delay time. So, in comparison with the chain of N flip-flops, the total operation speed may be greatly fast in the latch according to the present invention.

While the present invention has been particularly shown and described with reference to exemplary embodiments thereof, it will be understood by those skilled in the art that various changes in form and details may be made therein without departing from the spirit and scope of the present invention as defined by the appended claims.

1. A method of detecting a phase, the method comprising:
latching in sequence an input signal to a reference signal and a plurality of delay signals different in phase from the reference signal, thereby generating first and second latch signals;
generating first and second lock discriminating signals by inputting the first and second latch signals, wherein the first and second lock discriminating signals include information concerning the phase of the reference signal and the phases of the delay signals, respectively;
generating a reset signal using the first and second lock discriminating signals;
reversing the first latch signal, the second latch signal, the first lock discriminating signal and the second lock discriminating signal using the reset signal; and
detecting phase difference between the reference signal and the delay signals using the reversed first and second lock discriminating signals.

2. The method of claim 1, wherein generating the first and second lock discriminating signals includes:
sending the first latch signal to a first flip-flop to generate the first lock discriminating signal; and
sending the second latch signal to a second flip-flop to generate the second lock discriminating signal.

3. The method of claim 1, wherein generating the reset signal includes performing the logical NAND operation for the first and second lock discriminating signals.

4. The method of claim 1, further including:
comparing the first lock discriminating signal with the second lock discriminating signal; and
generating a comparison signal having information concerning the comparison result.

5. The method of claim 1, wherein logic level of the input signal is high.

6. The method of claim 5, wherein the delay signals have in sequence predetermined phase difference from the reference signal.

7. A method of detecting a phase, the method comprising:
latching an input signal having high logic to a plurality of delay signals, thereby generating first and second latch signals, wherein the delay signals have in sequence predetermined phase difference from the reference signal;
sending the first and second latch signals to D flip-flops so that the D flip-flops may operate to generate first and second lock discriminating signals having information concerning phases of the reference signal and the delay signals, respectively;
performing a logical NAND operation on the first and second lock discriminating signals to generate a reset signal;
reversing the latch signals and the lock discriminating signals using the reset signal; and
detecting phase difference between the reference signal and the delay signals using the reversed first and second lock discriminating signals.

8. The method of claim 7, wherein generating the first and second lock discriminating signals includes:
sending the first latch signal to a first D flip-flop to generate the first lock discriminating signal; and
sending the second latch signal to a second D flip-flop to generate the second lock discriminating signal.

9. The method of claim 7, further including:
comparing the first lock discriminating signal with the second lock discriminating signal; and
generating a comparison signal having information concerning the comparison result.

10. A phase detector comprising:
a false lock preventing section for latching in sequence an input signal to a reference signal and a plurality of delay signals different in phase from the reference signal, thereby generating first and second latch signals;
a lock discriminating section for generating first and second lock discriminating signals when the first and second latch signals are received, wherein the first and second lock discriminating signals include information concerning the phase of the reference signal and the phases of the delay signals, respectively, ; and
a reset section for reversing the latch signals and the lock discriminating signals when the first and second lock discriminating signals are received.

11. The phase detector of claim 10, wherein a logic level of the input signal is high.

12. The phase detector of claim 11, wherein the delay signals have in sequence predetermined phase difference from the reference signal.

13. The phase detector of claim 10, further including a comparing section for comparing the first lock discriminating signal with the second lock discriminating signal to generate a comparison signal having information concerning the comparison result.

14. The phase detector of claim 10, wherein the false lock preventing section includes:
a first latch section for latching the input signal to the reference signal to generate the first latch signal; and
a second latch section for latching in sequence the first latch signal to the delay signals to generate the second latch signal.

15. The phase detector of claim 14, wherein the first latch section includes at least two latches.

16. The phase detector of claim 14, wherein the second latch section includes at least two latches.

17. The phase detector of claim 16, wherein the latches are coupled in series.

18. The phase detector of claim 17, wherein the latches are D latches.

19. The phase detector of claim 10, wherein the lock discriminating section includes:
a first lock discriminator for generating the first lock discriminating signal when the first latch signal is received; and
a second lock discriminator for generating the second lock discriminating signal when the second latch signal is received.

20. The phase detector of claim 19, wherein the first lock discriminator includes a first flip-flop.

21. The phase detector of claim 20, wherein the second lock discriminator includes a second flip-flop.

22. The phase detector of claim 21, wherein the first flip-flop is coupled in parallel to the second flip-flop.

23. The phase detector of claim 22, wherein the first and second flip-flops are D flip-flops.

24. The phase detector of claim 10, wherein the reset section includes a NAND gate.

25. A phase detector comprising:
a false lock preventing section for latching an input signal having high logic to a plurality of delay signals, thereby generating a first and second latch signals, wherein the delay signals have predetermined phase difference from the reference signal;
a lock discriminating section for allowing the first and second latch signals to pass through D flip-flops so that first and second lock discriminating signals having information concerning the phases of the reference signal and the delay signals may be generated; and
a reset section for performing a logical NAND operation on the first and second lock discriminating signals to generate a reset signal, wherein the reset signal reverses the first latch signal, the second latch signal, the first lock discriminating signal and the second lock discriminating signal.

26. The phase detector of claim 25, wherein the false lock protecting section includes:
a first latch section for latching the input signal to the reference signal to generate the first latch signal; and
a second latch section for latching in sequence the first latch signal to the delay signals to generate the second latch signal.

27. The phase detector of claim 26, wherein the first latch section includes two latches.

28. The phase detector of claim 26, wherein the second latch section includes a plurality of latches coupled in series.

29. The phase detector of claim 28, wherein each of the latches is a D latch.

30. The phase detector of claim 25, further including a comparing section for comparing the first lock discriminating signal with the second lock discriminating signal to generate a comparison signal having information concerning the comparison.

31. The phase detector of claim 25, wherein the lock discriminating section includes:
a first lock discriminator for allowing the first latch signal to pass through a first D flip-flop so that the first lock discriminating signal is generated; and
a second lock discriminator for allowing the second latch signal to pass through a second D latch so that the second lock discriminating signal is generated.

32. The phase detector of claim 31, wherein the first D flip-flop is coupled in parallel to the second D flip-flop.
